(19) United States
(12) Patent Application Publication
(10) Pub. No.: US 2019/0018644 A1
(43) Pub. Date: Jan. 17, 2019

(54) SOUNDSHARING CAPABILITIES APPLICATION

(71) Applicants: JOSH KOVACEVIC, SOUTH JORDAN, UT (US); BRETT SMITH, SOUTH JORDAN, UT (US)

(72) Inventors: JOSH KOVACEVIC, SOUTH JORDAN, UT (US); BRETT SMITH, SOUTH JORDAN, UT (US)

(21) Appl. No.: 16/116,798

(22) Filed: Aug. 29, 2018

Related U.S. Application Data
(63) Continuation-in-part of application No. 16/034,927, filed on Jul. 13, 2018.
(60) Provisional application No. 62/531,878, filed on Jul. 13, 2017.
(60) Provisional application No. 62/551,222, filed on Aug. 29, 2017.

(51) Int. Cl. G06F 3/16; G06F 3/0482; G06Q 50/00

(52) U.S. Cl. CPC G06F 3/165; G06Q 50/01; G06F 3/0482

(57) ABSTRACT

Sharing an online music listening session allows users to listen to the same music at the same time. Sharing a music listening experience can further include listening to real-time events and forums and sharing music with social media.

### BACKGROUND

Wireless earbuds are a game-changing addition to the space of electronics. They enable an ease of listening to music using a simple component that fits into a user's ear. Users are free to move from location to location unhindered by cables or other components. Also, users may listen to all types of music using controls located on their mobile devices, controls on the earbuds themselves, or even voice commands.

Even with all of the advantages that earbuds provide, the ultimate performance of earbuds still depends largely on sound quality. Therefore, a growing need exists for improvements to earbuds to enhance aspects related to sound and the listening experience therein.

Listening to music with an electronic device is now commonplace, whether it be listening to music on a computer, laptop, mobile phone, tablet, smart watch, mp3 player, or other device. Furthermore, listening to music can be a social experience when users share music, such as music playlists, and even real-time content, with one other. Users are limited, however, in methods and forums of sharing music. This limits communication and the possible shared experience that could occur.

One of the most powerful ways to connect to other human beings is through music. Social media song editing provides emotion and connection. In fact, social media song editing is all about person interaction and emotion. By adding live music to communication, a user has the ability to add emotion to a message and create content that replaces regular text in social media, in essence, adding true music attachment.

What is needed are improvements to enhance the social experience of sharing music.

### DESCRIPTION OF THE DRAWINGS

FIG. 1 illustrates a pair of earbuds enhanced by a smart listening experience.

FIG. 2a illustrates an exemplary graphical representation of hearing levels as determined by a sound test.

FIG. 2b illustrates an exemplary graphical representation of hearing levels as determined by a sound test and a modification to the hearing levels.

FIG. 3 illustrates a smart listening experience that includes a computing device in communication with a computing system with AI.

FIG. 4 illustrates a pair of earbuds in communication with a computing system with AI.

FIG. 5 illustrates data sources that are available to a computing system with AI.

FIG. 6 illustrates data being sent from both earbuds and data sources to a computing system with AI.

FIG. 7 illustrates external information being sent to earbuds in relation to a computing system with AI.

FIG. 8 illustrates real-time auto-populated data being made available to a computing system with AI.

FIG. 9 illustrates parental control features being made available to a computing system with AI.

FIG. 10 illustrates doctor-prescribed settings being made available to a computing system with AI.

FIG. 11 illustrates an exemplary user interface with user-defined selections that are then used to control features of a smart listening experience.

FIG. 12 illustrates a system with modules that implement various features and aspects of a smart listening experience.

FIG. 13 illustrates a flow chart for implementing aspects of the system.

FIG. 14a illustrates an example shared music listening experience by a plurality of users.

FIG. 14b illustrates a diagram of an exemplary networked environment used to implement features presented herein.

FIG. 14c illustrates a diagram of an exemplary networked environment used to implement features presented herein.

FIG. 14d illustrates a diagram of an exemplary networked environment used to implement features presented herein.

FIG. 15 illustrates a flow chart for implementing aspects of the system.

FIG. 16 illustrates a flow chart for implementing aspects of the system.

FIG. 17 illustrates an exemplary user display interface for having a shared music listening experience.

FIG. 18 illustrates an exemplary user display interface for having a shared music listening experience.

FIG. 19 illustrates an exemplary user display interface for having a shared music listening experience.

FIG. 20 illustrates an exemplary user display interface for having a shared media listening experience.

### DETAILED DESCRIPTION

The present application is a Continuation-In-Part Application of U.S. patent application Ser. No. 16/034,927 filed Jul. 13, 2018, which claims priority to U.S. Provisional Application No. 62/531,878 filed Jul. 13, 2017. The present application also claims priority to U.S. Provisional Application No. 62/551,222 filed Aug. 29, 2017.

The following discloses a computer-implemented system that uses artificial intelligence (“AI”) to enable a smart, or custom, listening experience, for an end user. A custom listening experience may include, for instance, a sound which compensates for low levels of hearing for a given user. Every person has a unique hearing profile and a custom listening experience can overcome the low levels by adjusting various frequencies, volume, and other sound features related thereto to provide a normalized or customized listening experience.

Additionally, a listening experience for a base song can be enhanced by applying characteristics of a set of other songs, e.g., songs of a particular style. For example, a particular note may occur in the base song with a certain frequency. In a set of songs of a particular style, a different note may be played with the same or similar frequency. The note in the base song may be replaced by the note from a set of style songs. Replacing the note in the base song with a note of similar frequency from a set of style songs may transform, in whole or in part, the genre of the base song. For example, if the set of style songs comprises country songs, but the base song comprises a rap song, replacing one or more notes from the base rap song with the identified note or notes from the set of country style songs enables songs to be played in a manner that is more characteristic of songs from a desired genre. For example, a country song can take on characteristics of a rock song. Alternatively, the country song can take on characteristics of a new country song or a country song played like it was made 50 years ago. Other characteristics that can change include frequency, bass, tempo, acoustics, pitch, timbre, beat, or other characteristics.

Tones that are used toward specific categories of music may be emphasized for a given user depending on user music preference type. This can be an option by music choice, equalizer sound test, and/or may be automatically adjusted via artificial intelligence. In an example, for a user that prefers flute melodies, flute melodies in certain types of music for that user could be elevated in sound.

The experience can further be made smart by accounting for a given external environment. For example, if a visitor starts a conversation with a user, the earbud may sense the conversation and pause or lower the volume of the current music playing.

In another variation, the custom listening experience may be restricted by parental controls. This allows parents to mute profane language, tweak the bass levels to a desirable level, restrict times of day, or have many other control rights. In another example, the experience may be subject to a doctor's prescription to restrict certain frequencies or decibel levels, high bass, and instruments, etc., to prevent hearing loss. Other smart features are described herein.

The description references earbuds for auditory benefits, however the AI techniques described herein apply to many different sound devices, including, for example, headphones, hearing aids, stereo speakers, computer speakers, other types of speakers, electronic devices, mobile phones and accessories, tablets, and other devices that include speakers. An exemplary sound is provided through the earbud, such as a wireless earbud, which is communicatively coupled with a mobile phone or to the earbud itself. The sound may be controlled by the app on the mobile phone or an app on the earbud. While the system is described as being implemented with an application (“app”) on a mobile phone, it may instead be a program on a computer, on the earbud itself, or other electronic devices known in the art, such as a smart watch, tablet, computing device, laptop, and other electronic device.

Platforms for the system may further include hardware, a browser, an application, software frameworks, cloud computing, a virtual machine, a virtualized version of a complete system, including virtualized hardware, OS, software, storage, and other platforms. The connection may be established using Bluetooth or other connectivity.

While various portions of the disclosed systems and methods may include or comprise AI, other types of machine learning, or knowledge or rule-based components, sub-components, processes, means, methodologies, or mechanisms (e.g., support vector machines, neural networks, expert systems, Bayesian belief networks, fuzzy logic, data fusion engines, classifiers, etc.) are anticipated. Such components, inter alia, can automate certain mechanisms or processes performed thereby to make portions of the systems and methods more adaptive as well as efficient and intelligent.

In collecting information, the program may collect information about a user and the previous user control and preferences. For example, preferred music type, volume control, and listening habits, and other information is collected. Data analytics and other techniques are applied to then guess what the user will want during upcoming listening experiences. The AI program can also act in real-time to customize the user experience as the user is listening and using controls. In essence, it can work as a personal custom deejay.

The AI program can also be incorporated with or work in conjunction with other applications, such as an equalization app that auto-customizes sound using a sound test, controls, and/or other methods.

Based on user response and how the individual hears specific tones and music frequencies, the data will then be used to adjust how the music is streamed or played on the device according to the user's response. This allows for the device's battery life to be preserved and will extend the length of playback time that is possible. Additionally, playback may respond according to the habits of the user for preferences of listening to certain genres of music, specific music artists, and/or ambient noise that's recognized through the physical location of the user at any given time. Data of this sort is collected and used to auto adjust the sound controls for music playback. In essence, the AI technology acts as a personal deejay for each user, but one that takes into account personal hearing specs as well as personal preferences in listening to music. This is a differentiating factor and functionality from that of the current music industry.

AI can also be utilized in the app interface customizing a landing page user experience as well. Populating tools and user page may be customized depending on the user actions. For example, a user that prefers rock music will auto populate information and music selections around rock and present them on the user page.

AI can populate tunes depending on user preferences. This can save battery life by adding or taking away non-needed tunes.

AI can auto adjust the sound equalizer to user preference. This can also be adjusted by the user as well as a starting base point and then changed from there.

AI may be implemented into an app to change and auto adjust to the user experience depending on user actions and preferences. This can relate to equalizer function, sound experience, app function, volume control, language control, playlist recommendation, speaker control, battery saver, auto adjustment of sound to a type of music, and/or muting through app.

Features may additionally include the ability for the user to have a pre-set option which can be turned on and off at any time but varies from the traditional functionality of AI in the sense that the data collected for the following features will actually be saved and remembered so that the user can quickly enable or disable the feature sets.

Included in the pre-set option or other features herein is an ad blocker feature. This feature would allow the user to choose whether or not the volume gets muted for an advertisement. If activated, the ad blocker feature would automatically lower and/or mute the playback volume during the portion of time that the app recognizes that an advertisement is being played. Note that master controls may embed the streaming of music and this allows the user to quickly override any preset features that have been enabled by simply pushing up or down on the device's volume controls.

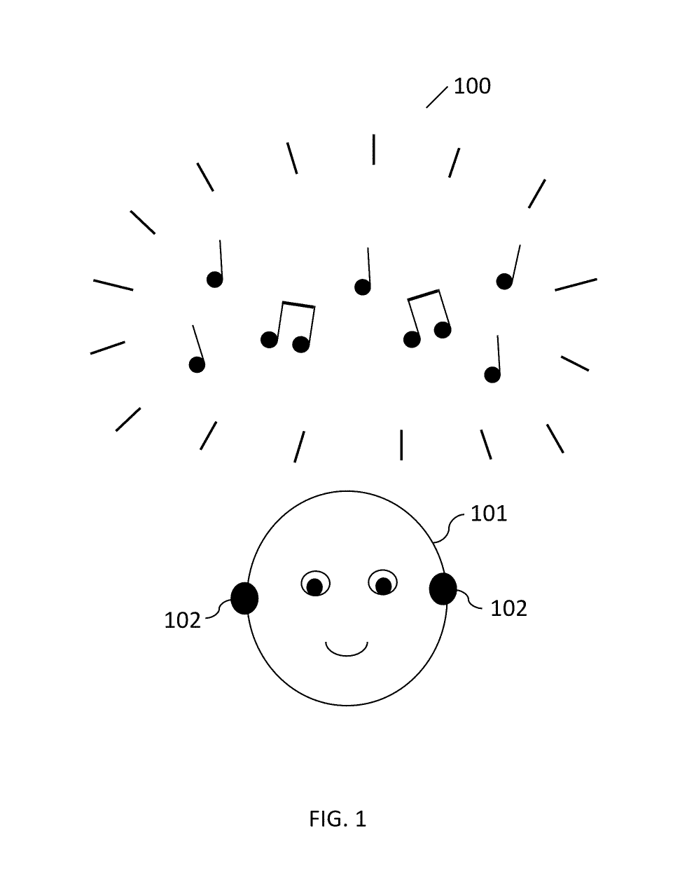

Turning to FIG. 1, a user 101 is shown listening to music with earbuds 102 and having a custom listening experience that is enhanced by an AI program as indicated by highlighting lines that frame music notes. An exemplary AI program is used to change the sound to auto customize a user's music experience.

An exemplary process of changing sound involves the equalization of earbuds. Equalization is the process of adjusting the balance between frequency components within an electronic signal. Exemplary equalization or other processing for audio listening includes control for left-right balance, voice, frequency, treble, bass, noise cancellation, sound feature reduction and/or amplification (e.g., tones, octaves, voice, sound effects, etc.), common audio presets (e.g., music enhancements, reduction of common music annoyances), decibel, pitch, timbre, quality, resonance, strength, etc. Equalization makes it possible to eliminate unwanted sounds or make certain instruments or voices more prominent. With equalization, the timbre of individual instruments and voices can have their frequency content adjusted and individual instruments can be made to fit the overall frequency spectrum of an audio mix.

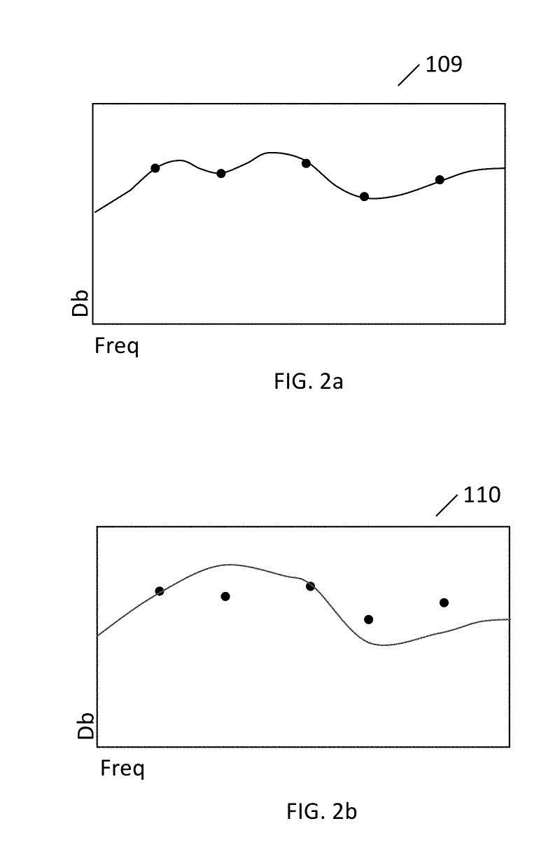

FIGS. 2a and 2b illustrate the exemplary process of equalization. FIG. 2a shows a sound test graph 109 with a curved line and reference points that indicate sound in decibels that a hypothetical user hears for a given range of frequencies. FIG. 2b shows an equalized graph 110 with a changed curved line with respect to the original reference points in FIG. 2a after the decibel levels have been altered to improve or correct for the decibels heard by the user. Even small changes can make a noticeable difference and make music sound more clear and thus better heard by the user. It can also affect other characteristics of music as discussed herein.

Further exemplary AI processes may use other known techniques, such as compression, for reducing the volume of loud sounds or amplifying quiet sounds.

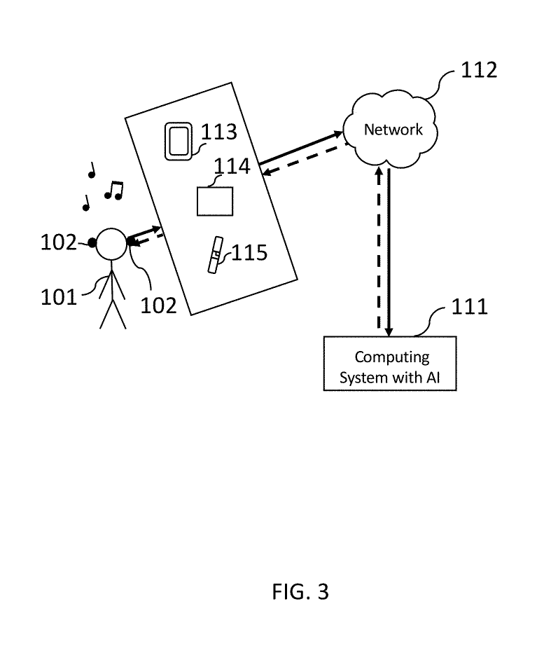

FIGS. 3-10 provide various conceptual illustrations of exemplary implementations of the system for providing a custom listening experience and will each be discussed in turn.

FIG. 3 illustrates a user 101 wearing a pair of earbuds 102 and having a custom listening experience. The earbuds are connected through an electronic device, as represented by exemplary mobile phone 113, laptop 114, and smart watch 115, which is connected over the network 112 to a computing system with AI 111. Data from the earbuds and/or electronic device is collected by the electronic device and sent through the network 112 to the computing system with AI 111, as indicated by solid arrows. The computing system with AI 111 receives the data and applies an artificial intelligence algorithm to the data to generate a customization rule that can then be applied to generate customization data. The customization data is then sent over the network 112, through the electronic device and received by the earbuds 102 to present a custom listening experience to the user 101.

The data received by the computing system with AI 111 may include user-defined preferences, such as preferred or active settings (e.g. volume, speed, left/right balance, equalization settings, etc.), playlists, history of music played, current music being played, physiological response of a user (touch control, voice activation, head movement, etc.), data from multiple users, external information (voice, background noise, wind, etc.), time of day, etc. Other types of data are also anticipated. The system recognizes user behavior in association with, for example, genres of music, music artists, sources of music streaming, etc. The system further associates with all kinds of other programs and apps, including Apple Music®, iTunes®, Sound Cloud®, Spotify®, Pandora®, iHeart Radio®, YouTube®, Sound Hand®, Shazaam®, Vimeo®, Vevo®, etc. For example, other apps will be able to receive a customized listening experience that can be shared, commented on, liked, and used for other generally known purposes.

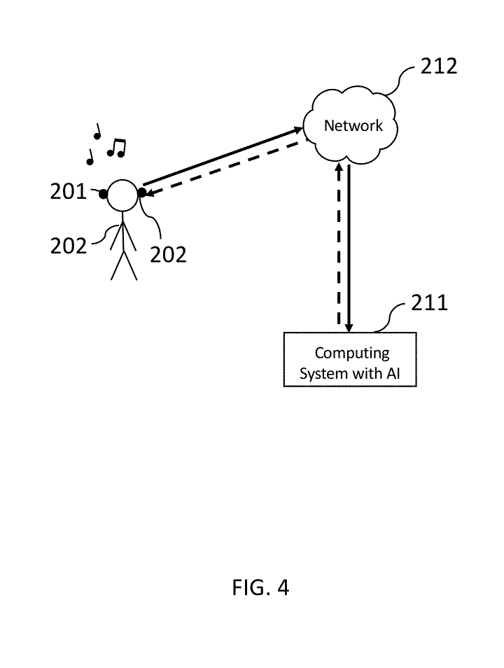

FIG. 4 illustrates a user 201 that is using earbuds 202 that connect directly over the network 212 to the computing system with AI 211. The connection can be any wireless connection, such as Bluetooth, WiFi, or other known wireless connection. In this example, the controls and data are located on the earbuds 202 themselves rather than a separate device. Data is sent automatically over the network, however, the data being sent may be controlled by user preferences or by manual control.

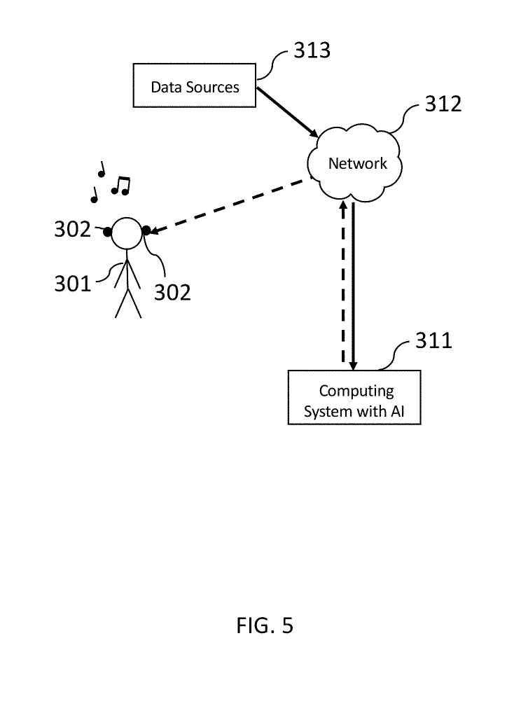

FIG. 5 illustrates the same system as shown in FIG. 3 but with the computing system with AI 511 having access to external data sources 313. The external data sources 313 provide, for example, listening patterns, music playlists, top chart songs, ranked songs, songs by genre, song data analytics, song characteristics, requested or standard equalization settings for songs, etc. The data sources are useful in providing information in which the computing system with AI 311 can use to generate customization rules for a base song or set of songs.

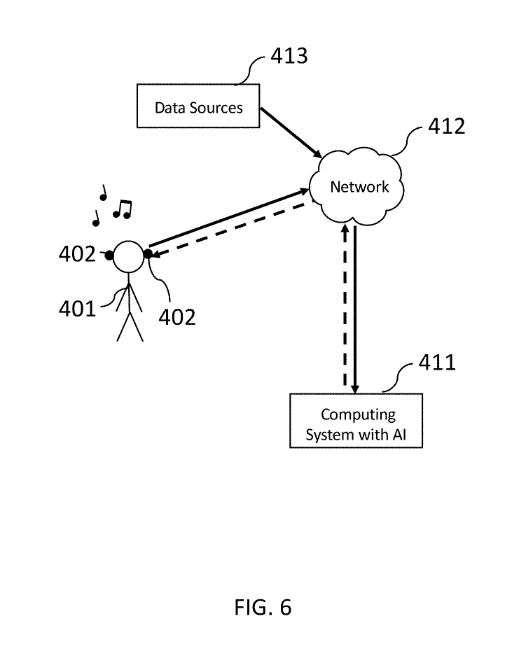

FIG. 6 illustrates the same system as shown in FIG. 4 but with the computing system with AI 411 having access to external data sources 413. The external data sources 413 provide for example, listening patterns, music playlists, top chart songs, ranked songs, songs by genre, song data analytics, song characteristics, requested or standard equalization settings for songs, etc. The data sources are useful in providing information that the computing system with AI 411 can use to generate customization rules for a base song or set of songs.

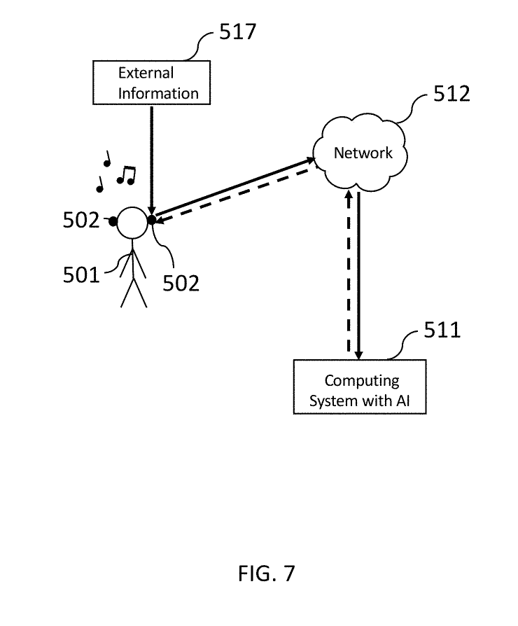

FIG. 7 illustrates the system having external information 517 being available to earbuds 502 of a user 501. The external information 517 may include ambient noise, human movement, environment conditions (e.g., rain, wind, temperature, etc.), and other information that can be processed by the earbuds and/or sent over the network 512 to the computing system with AI 511.

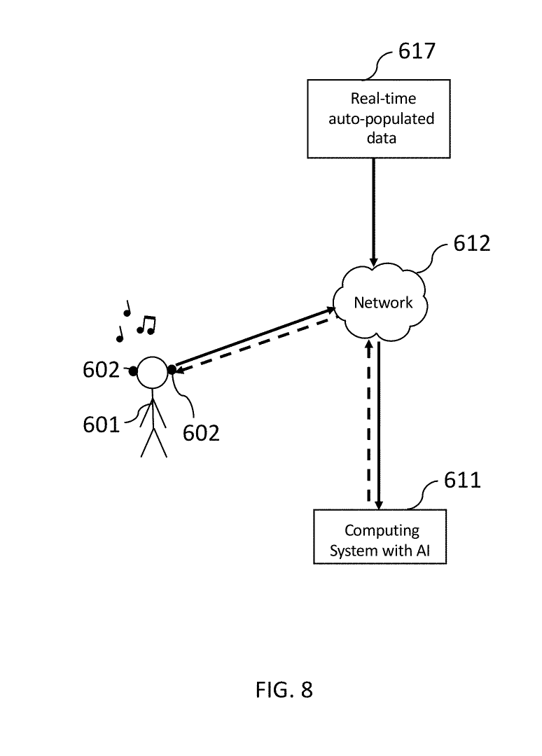

FIG. 8 illustrates the system having real-time auto-populated data 617 being available over the network 612 to the computing system with AI 611. The data 617 includes all types of dynamic data that can be updated in real-time and be raw or have pre-processing before being sent to the computing system with AI. The data 617 enables the computing system with AI 611 to have up-to-date information so that the rules applied to a listening experience are as advanced as they can be. The system uses the data to not only generate new custom rules, but it further allows the system to update previously generated custom rules.

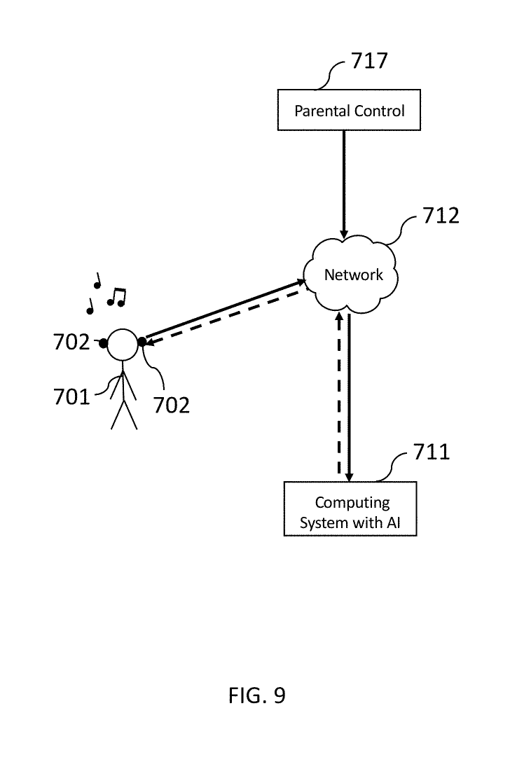

FIG. 9 illustrates that the system may have parental control 717 over the network 712. Parental control 717 may be applied by the computing system with AI 711. Examples of parental control can include a plethora of rights, such as control over times allowed for listening, restrictions on profanity, earbud location finding tools, volume and other sound characteristic controls, etc. The computing system with AI 711 generates custom rules that incorporate the parent control rights 717 and sends them to the earbuds 702 of the user 701 over the network 712. Note that the parental control 717 may also incorporate data sent over the network by the earbuds 702 to generate custom rules.

Similarly, the user may have a personal filter for profane language, vulgarity, explicit words and lyrics. This feature allows the user to either manually block a choice of words or have the system automatically recognize obscene language. The feature then responds by giving the user a music playback/streaming experience that is free from the use of this type of language. AI can auto cutout certain explicit words and lyrics by preference of user. In another example, the app can automatically adjust by AI depending on user actions.

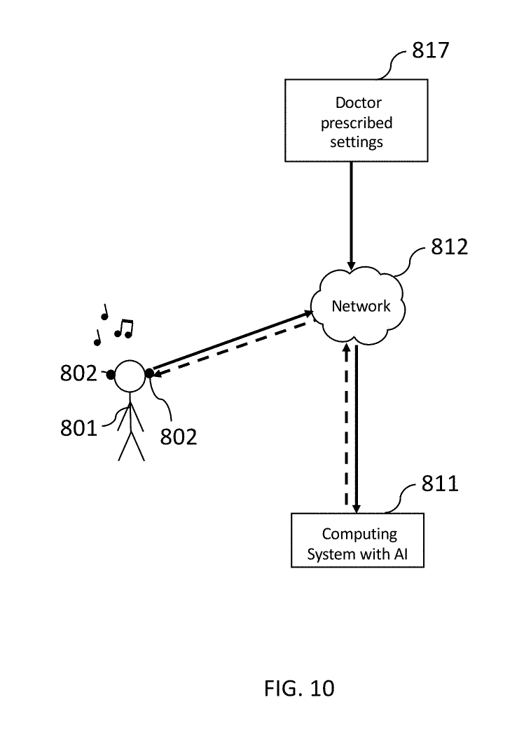

FIG. 10 illustrates the system having doctor-prescribed settings 817 being made available over the network 812 to the computing system with AI 811. Doctor prescribed settings may be used to limit music in a manner that prevents hearing loss by controlling characteristics of music as described herein.

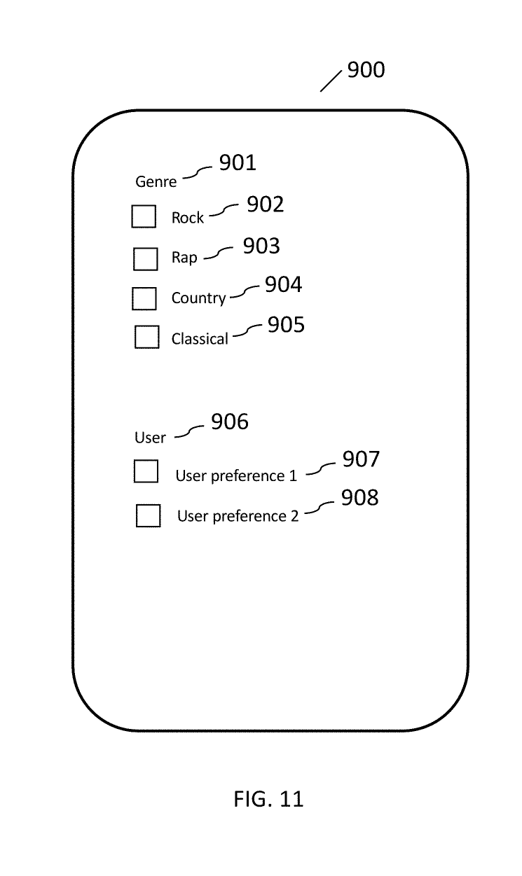

For aspects of the system that are controlled via a touch screen user interface, an exemplary interface 900 is shown in FIG. 11. A user interface provides selections that may be controlled, such as the selection of a particular genre 901 with options such as rock 902, rap 903, country 904, and classical 905. The type of genre selected may be used by the system to suggest further music (specific songs, playlists, etc.) of that type of genre that the user may enjoy. Alternatively, the type of genre selected may be used to modify music that the user selects into being more like that type of genre in terms of musical characteristics described herein. The type of genre may be used to generate other custom rules as well.

The user may opt to have more than one user profile 906 as denoted by first user preference 907 and second user preference 908, based on which the system may generate custom rules. For example, a parent and a child may each have their own user profile. The custom rules are then tailored to the specific listening experiences, desires, and settings for each user rather than combining them into a jumbled customized rule set.

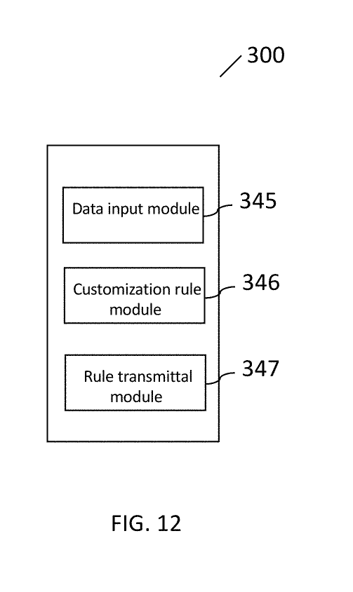

Various modules may be used to implement the system discussed herein. Turning to FIG. 12, an exemplary audio customization system comprises a data input module 345 that includes a computing device and computer-readable instructions to direct the computing device to receive customization data and provide customization to a customization rule module 346. The customization rule module 346 includes a computing device and computer readable instructions that direct the computing device to apply an artificial intelligence algorithm to the customization data to thereby generate a customization rule set based on the customization data.

The data input module 345 includes customization data, which may include at least one or more of user-defined preferences; user listening patterns; data sources; external information; real-time auto-populated data; parental control settings; a physiological response of a user; equalization data; and doctor prescribed settings. Exemplary equalization data is based on a sound test on a user. The customization rule set comprises at least one customization rule.

In one example, the customization data comprises a user tone map. The user tone map comprises a tone deficiency; and the customization rule set comprises a rule to compensate for the tone deficiency by amplifying an associated tone.

In another example, the customization data comprises a song set comprising at least one song. The system applies an artificial intelligence algorithm that includes mapping a note from the song to a plurality of measurable tonal qualities. The resulting customization rule set is based at least in part on the plurality of measurable tonal qualities.

In another example, the customization data comprises a song set comprising at least one song. The system applies the artificial intelligence algorithm to determine at least one sound characteristic of the song set. The customization rule set is based at least in part on the at least one sound characteristic. The song set may comprise at least two songs where all songs in the song set share a common genre.

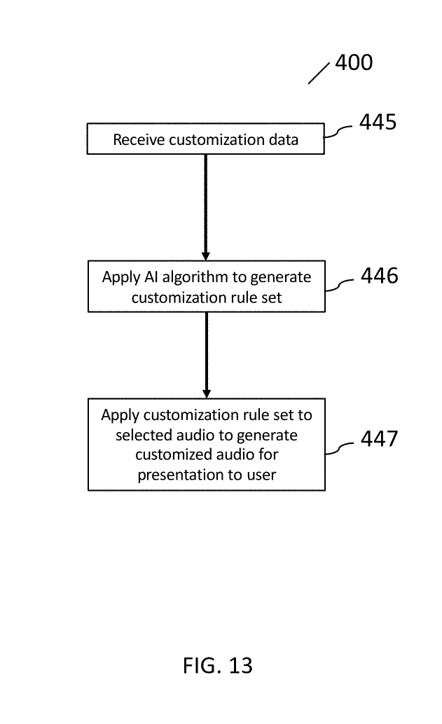

The method implemented by the system may be described and expanded upon based on the flow chart 400 referenced to in FIG. 13. In step 445, the computer system with AI receives customization data. In step 446, the system applies an artificial intelligence algorithm to the customization data to generate a customization rule set based on the customization data.

The customization data includes, for example, one or more of a user's physiological response metrics, ambient sound, ambient light, currently played music, a user's active choice of music, and a user's active response. The active choice of a user includes conscious music selections and in-time conscious responses. The active choice of a user may include music genre choice and/or volume control during each music being played. Alternatively, the active response of a user may include volume and settings adjustments.

Other examples of active choices may include a selected musical piece; a selected music playlist; a modified frequency profile; a modified tone profile; a modified volume profile; a modified or deleted language content of a musical piece; and selected output from control to another app. The deleted language content may include, for example, the deletion of vulgarity or a translation of language.

In step 447, the system applies the customization rule set to base audio to generate customized audio.

In common circumstances of today, people are often on the go and separated from loved ones and friends for extended periods of time. Even when people do not or cannot share the same space, they still want a meaningful connection with people they care about. One way to accomplish this is through sharing a similar experience. A powerful similar experience is often felt through music. Sharing the same music is one way that people can still connect by sharing a powerful experience together while being away from each other. Sharing music is desired for other reasons as well. People may want to listen to the same music that people they admire listen to. People may want to share their music with others in order to promote their musical talents. In short, there are many reasons for sharing music and creating shared listening sessions.

Furthermore, people may want to listen to music in the exact same form as other people. Music enhanced by various methods described herein, including music enhanced by AI and with user-defined enhancements to bass, frequency, etc., as described previously, are example features that can be shared as well.

A exemplary method for sharing a listening session includes providing one or more listening session identifiers, receiving a selected listening session identifier, and providing access to a listening session associated with the selected listening session identifier.

An example computer system includes a processor, a storage coupled to the processor and at least one user interface device to receive input from a user and present material to the user in human perceptible form. An instruction set is stored on the storage and when executed causes the computer system to present through the user interface a selection interface for selecting an audio listening session, receive through the user interface a selection of an audio listening session, and present through an audio output interface audio content based on the selected audio listening session.

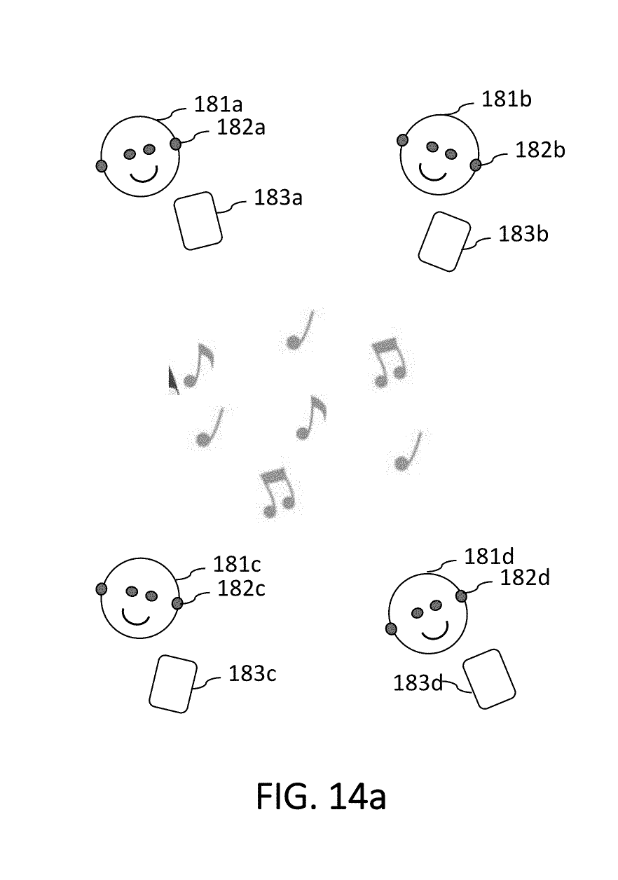

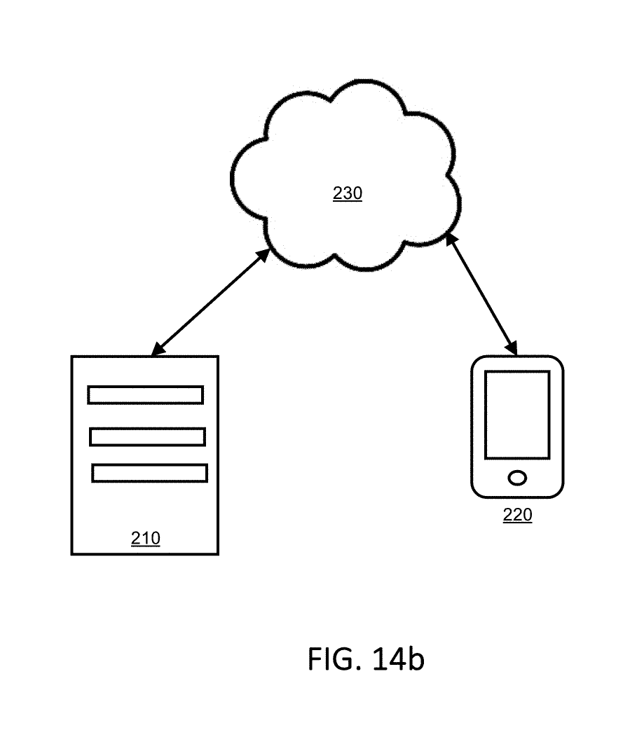

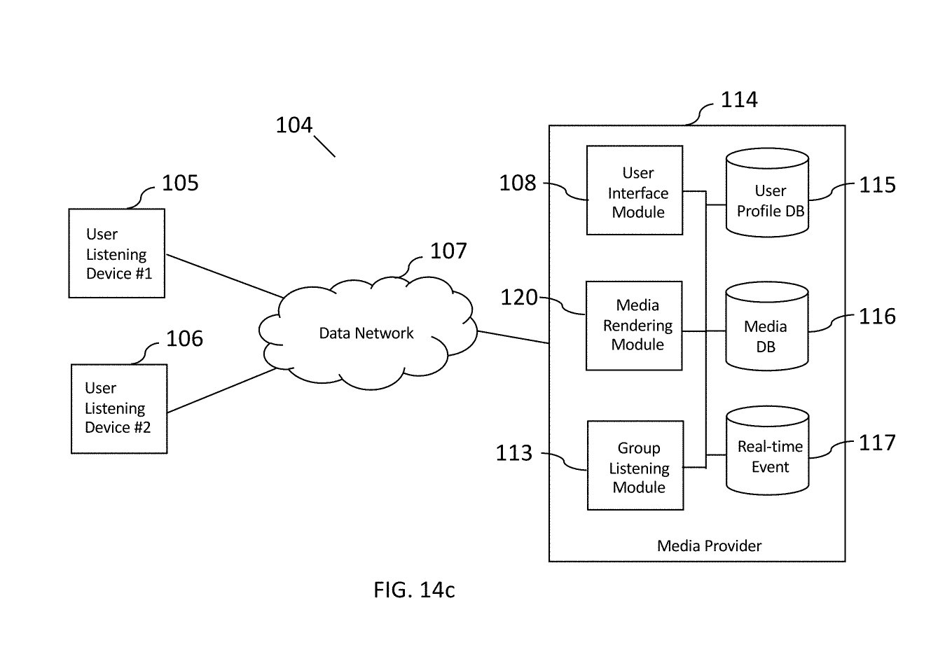

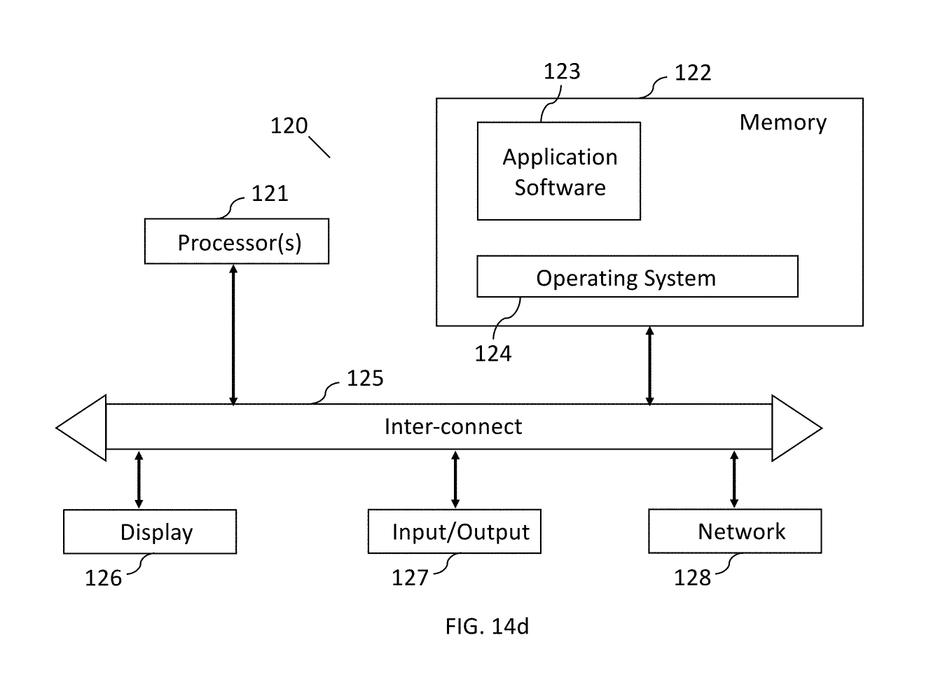

FIG. 14a depicts an example system for sharing a listening session. Examples of a listening session include one or more of a real-time audio content, a series of media files such as a playlist, or media through an Internet station or channel. Further, media may include music, video, images, text, podcasts, ebooks, articles, and in general media files in digital media formats currently known, or to become known in the future.

The exemplary sound sharing experience shown includes a group of individuals 181a, 181b, 181c, and 181d using their respective mobile phones 183a, 183b, 183c, 183d, and 183d to engage in a shared music listening experience. Each user is wearing wireless earbuds 182a, 182b, 182c, and 182d that connect to their respective phones. Using their phones and/or earbuds, each user “taps into” or in other words, uses their phones and/or earbuds to connect to a shared music listening session. The phones include a software application or app that allows them to create, select, and/or engage in such music listening sessions.

While the illustration shows mobile phones, other computing devices may be utilized, as described previously.

FIGS. 14b, 14c, and 14d show example environments that may be used for sharing a listening sessions.

Turning to FIG. 14b, an exemplary networked environment is shown for implementing features discussed herein. The environment includes an exemplary computing device 220 represented in the form of a mobile device in communication via a software application over a network 230. The environment further includes a presentation server 210 in communication over the network 230 with the computing device 220.

The presentation server 210 may comprise a computing device designed and/or configured to execute computer instructions, e.g., software, that may be stored on a non-transitory computer readable medium. For example, but without limitation, presentation server 210 may comprise a server including at least a processor, volatile memory (e.g., RAM), non-volatile memory (e.g., a hard drive or other non-volatile storage), one or more input and output ports, devices, or interfaces, and buses and/or other communication technologies for these components to communicate with each other and with other devices.

Computer instructions may be stored in volatile memory, non-volatile memory, another computer-readable storage medium such as a CD or DVD, on a remote device, or any other computer readable storage medium known in the art. Communication technologies, e.g., buses or otherwise, may be wired, wireless, a combination of such, or any other computer communication technology known in the art.

Presentation server 210 may alternatively be implemented on a virtual computing environment, or implemented entirely in hardware, or any combination of such. Presentation server 210 is not limited to implementation on or as a conventional server, but may additionally be implemented, entirely or in part, on a desktop computer, laptop, smart phone, personal display assistant, virtual environment, or other known computing environment or technology. A server may comprise a plurality of servers in connection with each other.

“Computing device” may refer to one of, or a combination of, a number of mobile or handheld computing devices, including handheld computers, smart phones, smart watches, tablet devices, and comparable devices that execute applications. In addition, “computing device” may refer to a device that has limited or no mobility, such as a laptop computer or a desktop computer. This includes, for example, earbuds that are activated by tapping on and tapping off to a listening session. The listening device can be a mobile phone or other mobile device with an audio output.

“Platform” as used herein, may refer to a combination of software and hardware components that enables features herein, such as capturing information from online sources. Examples of platforms include, but are not limited to, a hosted service executed over a plurality of servers, an application executed on a single computing device, and comparable systems.

To “present,” as used herein, includes but is not limited to, providing data through interface elements or controls, e.g., through a web page, application, app, audible interface, or other user interface known in the art. For example, “presenting” may comprising providing visual display elements or controls through a web browser on a computer display or smartphone display. “Presenting” may also include providing input controls or elements.

A user interface on or coupled with the computing device is capable of presenting information to a user and receiving input from a user. The computing device 220 may be in communication with presentation server 210 via any communication technology known in the art, including but not limited to direct wired communications, wired networks, direct wireless communications, wireless networks, local area networks, campus area networks, wide area networks, secured networks, unsecured networks, the Internet, any other computer communication technology known in the art, or any combination of such networks or communication technologies. In a preferred embodiment, the computing device communicates with presentation server 210 via network 230, which may be the Internet, network, or cloud. An application programming interface (API) may be a set of routines, protocols, and tools for the application or service that enable the application or service to interact or communicate with one or more other applications and services managed by separate entities.

The participant interacts with the application through a touch-enabled display interface of the computing device 220. The computing device 220 may alternatively include a monitor with a touch-enabled display component to provide communication to a user. A user may interact with the application by one or more of touch input, gesture input, voice command, sound input, eye tracking, gyroscopic input, pen input, mouse input, and keyboard input. The computing device 220 may comprise any computing device capable of displaying information and receiving input from a user. The device 220 may include, but is not limited to, a keyboard, mouse, touchscreen, trackpad, holographic display, voice control, tilt control, accelerometer control, or any other computer input technology known in the art.

For example, as shown in FIG. 14c, a listening session may be provided by a media provider 114 through a data network 107. User interface module 108 provides the user with a display of selections as well as controls for a listening session. A user listening device #1 105 uses an electronic device to request a listening session of user listening device #2 106. The request is sent over a data network 107 to media provider 114. Upon receiving the request from the interface module 108, the rendering module 120 searches the media database 116 and retrieves the correct audio file or files corresponding to the request by the consumer. The rendering module 120 can be configured to further communicate with the interface module 108 so as to transmit the retrieved audio file to the user listening device #1 105. Group listening module 113 provides a listening session or other content for sharing among a plurality of users.

Also, content accessed by a user listening device can come from a consumer computing device, the user listening device itself, or from other sources or media services (not shown) via data network 107. In one embodiment, Group listening module 113 may provide a listening session by providing identification of particular music and timepoint(s) in such music, so that a user listening device may then retrieve the music from the user listening device itself, or from other sources, e.g., YouTube®. In another embodiment, group listening module 113 may provide a listening session by providing references, e.g., one or more URL(s), to locations where the content associated with a music listening session may be retrieved.

While various modules have been described herein, one skilled in the art will recognize that each of the aforementioned modules can be combined into one or more modules, and be located either locally or remotely. Each of these modules can exist as a component of a computer program or process, or be implemented as a combination of hardware, software or firmware, or be standalone computer programs or processes stored in a data repository.

FIG. 14d depicts a component diagram of one example of a listening device 120. An example listening device 120 is a user computing device that can be utilized to implement one or more computing devices, computer processes, or software modules described herein. In one example, the listening device 120 can be utilized to process calculations, execute instructions, and receive and transmit digital signals, as required by the listening device 120. In one example, the listening device 120 can be utilized to process calculations, execute instructions, and receive and transmit digital signals, as required by user interface logic, video rendering logic, decoding logic, or search engines as discussed below.

The listening device 120 can be any general or special purpose computing device now known or to become known capable of performing the steps and/or performing the functions described herein, either in software, hardware, firmware, or a combination thereof. The listening device 120 shown includes an interconnect 125 (e.g., bus and system core logic), which interconnects a microprocessor(s) 121 and memory 122. The inter-connect 125 interconnects the microprocessor(s) 121 and the memory 122 together. Furthermore, the interconnect 125 interconnects the microprocessor 121 and the memory 122 to peripheral devices such as input ports 127 and output ports 127. Input ports 237 and output ports 127 can communicate with I/O devices such as mice, keyboards, modems, network interfaces, printers, scanners, video cameras and other devices. In addition, the output port 127 can further communicate with the display 126.

Furthermore, the interconnect 125 can include one or more buses connected to one another through various bridges, controllers and/or adapters. In one embodiment, input ports 127 and output ports 127 can include a USB (Universal Serial Bus) adapter for controlling USB peripherals, and/or an IEEE-1394 bus adapter for controlling IEEE-1394 peripherals. The interconnect 125 can also include a network connection 128.

The memory 122 can include ROM (Read Only Memory), and volatile RAM (Random Access Memory) and non-volatile memory, such as hard drive, flash memory, etc. Volatile RAM is typically implemented as dynamic RAM (DRAM), which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory can also be a random access memory.

The memory 122 can be a local device coupled directly to the rest of the components in the data processing system. A non-volatile memory that is remote from the system, such as a network storage device coupled to the data processing system through a network interface such as a modem or Ethernet interface, can also be used. The instructions to control the arrangement of a file structure can be stored in memory 122 or obtained through input ports 127 and output ports 127.

In general, routines executed to implement one or more embodiments can be implemented as part of an operating system 124 or a specific application, component, program, object, module or sequence of instructions referred to as application software 123. The application software 123 typically comprises one or more instruction sets, stored on a computer readable medium that can be executed by the microprocessor 121 to perform operations necessary to execute elements involving the various aspects of the methods and systems as described herein. For example, the application software 123 can include video decoding, rendering and manipulation logic.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media and optical storage media (e.g., Compact Disk Read-Only Memory (CD ROMS), Digital Versatile Disks, (DVDs), etc.), among others. The instructions can be embodied in digital and analog communication links for electrical, optical, acoustical or other forms of propagated signals, such as carrier waves, infrared signals, digital signals, etc.

While some embodiments may be described in the general context of program modules that execute in conjunction with an application program that runs on an operating system on a personal computer, those skilled in the art will recognize that aspects may also be implemented in combination with other program modules.

Generally, program modules used to carry out features herein include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process or method, a computing system, or as an article of manufacture, such as a computer program product or computer readable media. The computer program product may be a computer storage medium readable by a computer system and encoding a computer program that comprises instructions for causing a computer or computing system to perform example processes. The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

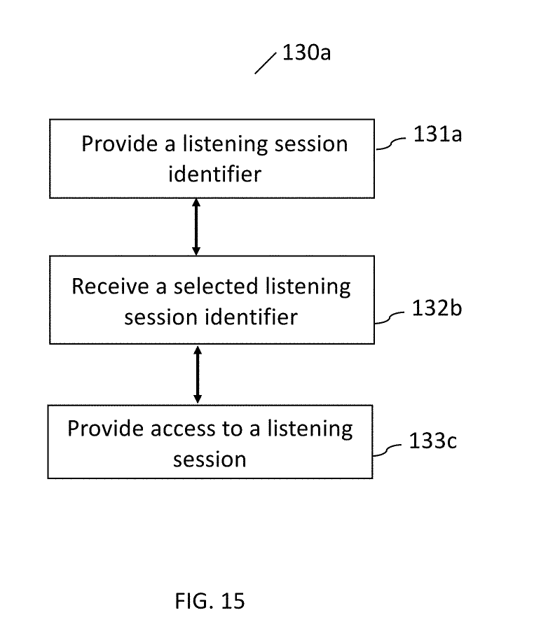

Turning to FIG. 15, a flowchart 130a is shown that describes example steps performed herein. In step 131a, a listening session identifier is provided. In step 132b, a selected listening session identifier is received. In step 133c, access to a listening session is provided.

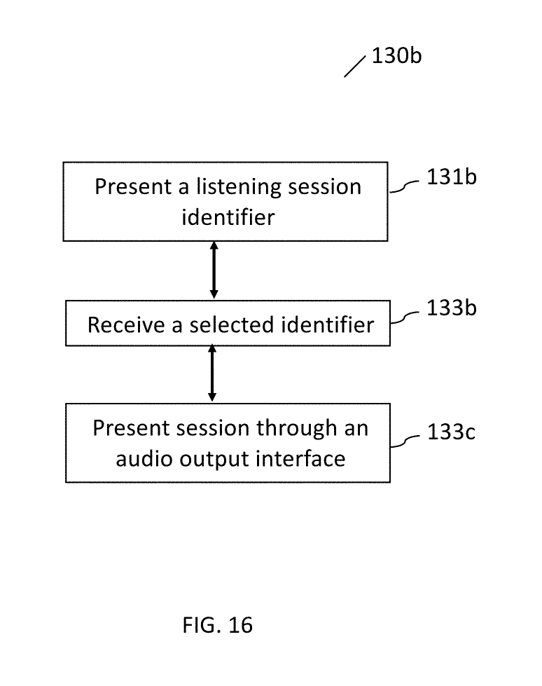

Turning to FIG. 16, a flowchart 130b is shown that describes example steps performed herein. In step 131b, a listening session identifier is presented. In step 133b, a selected identifier is received. In step 133c, a listening session associated with the identifier is presented through an audio output interface.

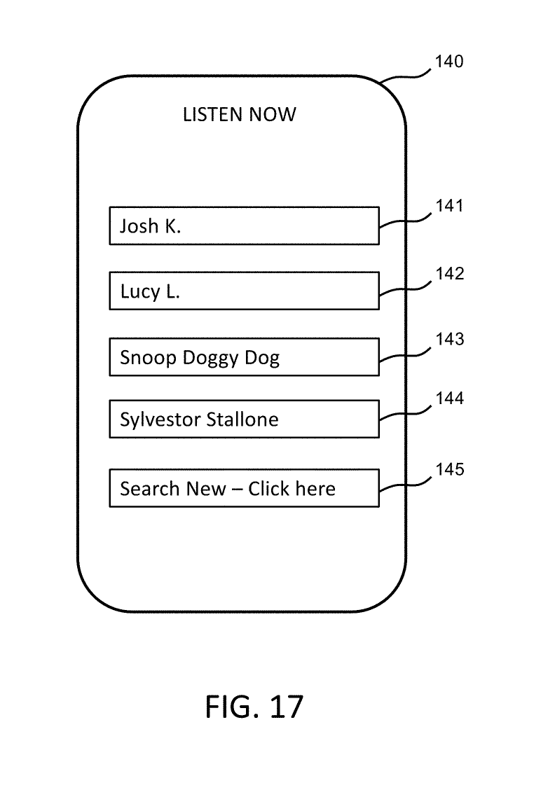

A shared listening experience can be accomplished by a user selecting a real-time music session of another user or entity. Turning to FIG. 17, an exemplary display interface is shown that presents exemplary controls. Controls show “Josh K.” 141 and “Lucy L.” 142 as people that have real-time music environments that the user can listen to. The people may be family, friends, acquaintances, or people otherwise known or connected to with the user. The people may be famous musicians, as shown by control with famous rap singer “Snoop Doggy Dog” 143. The people may be famous, as shown by control with famous actor “Sylvester Stallone” 144. Searches may also be conducted for persons or entities of interest, as indicated by control with “Search New—Click here” 145.

Note that listening preferences and AI enhanced listening and other features described previously can be shared as well.

The people whose music listening sessions may be selected, e.g., “Josh K.,” “Lucy L.,” “Snoop Doggy Dog,” and “Sylvestor Stallone” in FIG. 17, may be currently listening to music and the user will thus listen to the same music at the same time as the selected music listening session. In other embodiments, the user may listen to a non-real-time music listening sessions, i.e., a music listening session that a person played previously, or a music listening session that another person designed or that may be been designed in whole or in part using a computer-implemented algorithm.

In an example, a user in America is listening to whatever his or her friend is listening to in China. The user in America may be listening to whatever is being listened to in real time, or it may be picking up the song and made to play in sync or close to a synced time, to thereby simulate the same listening experience. In this sense, it mirrors the friend's listening experience in China.

In another example, a user in Chicago logs in and listens to a saved playlist of music being played by his girlfriend at a gym in Utah. The user can also save the playlist and listen to it at a later more convenient time, for example, when the user opts to go the gym. In this manner, the user and the user's girlfriend can have a shared listening experience and feel a sense of togetherness while they are apart.

Control of music can also be shared. For example, a husband and wife that work out together when they take a business trip together can tap into each other's music. One person can control the music being listened to on their wireless earbuds. If the wife controls the music, if she pauses the music on her end, the music is paused on the husband's end.

Another shared listening experience can be accomplished by a user selecting a real-time music environment of a group.

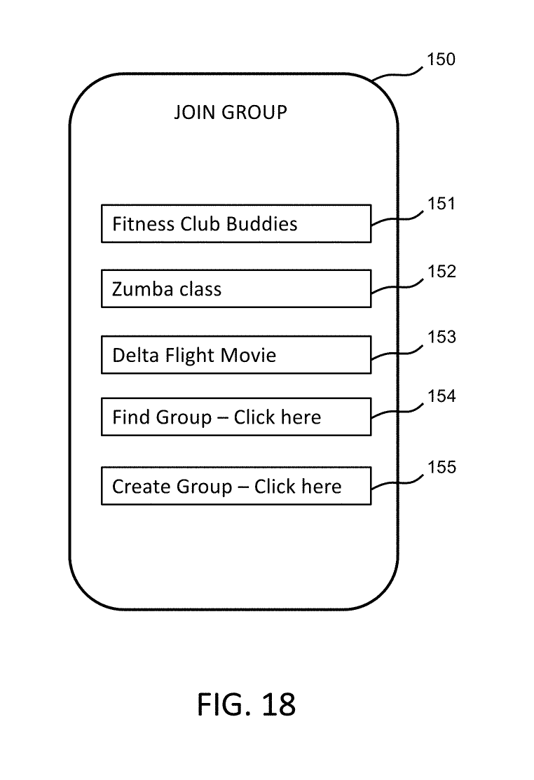

Turning to FIG. 18, an exemplary display interface is shown that presents exemplary controls. Control “Fitness Club Buddies” 151 allows a user to to listen to the same music as his or her friends at the gym. Control “Zumba class” 152 allows a user to listen to the same music as other members of a Zumba class. Control “Delta Flight Movie” 153 allows a user to listen to the same movie as someone else as shown on a Delta flight. Control “Find Group—Click here” 154 allows a user to find a group to join. The listening session could be based on similar interests, activity, location, sports training, event, travel log, etc. Control “Create Group—Click here” 155 allows a user to create a group that others can join to share a real-time listening experience.

The user experience may include a tracker, which allows users to track their distance covered during a listening experience. For example, during a shared listening experience in the gym, a user could track the distance covered on a treadmill or stairclimber. Any kind of tracker can be used, such as a heart rate monitor, calories burned, sleep (e.g. time spent in light, REM sleep), and any kind of headphone can be used, such as Bragi, Jabra, and others. In conjunction with headphones/earbuds, the user experience may include a feature that displays the remaining battery life of headphones/earbuds that are being used with the application.

The user experience may further include equalization that adjusts the driver and amplifies certain sounds that are within hearing, ignores other sounds, and performs other functions to provide customized sound. For example, music style, playlists, and bass boost may be customized to provide a unique listening experience for each user during a shared listening experience.

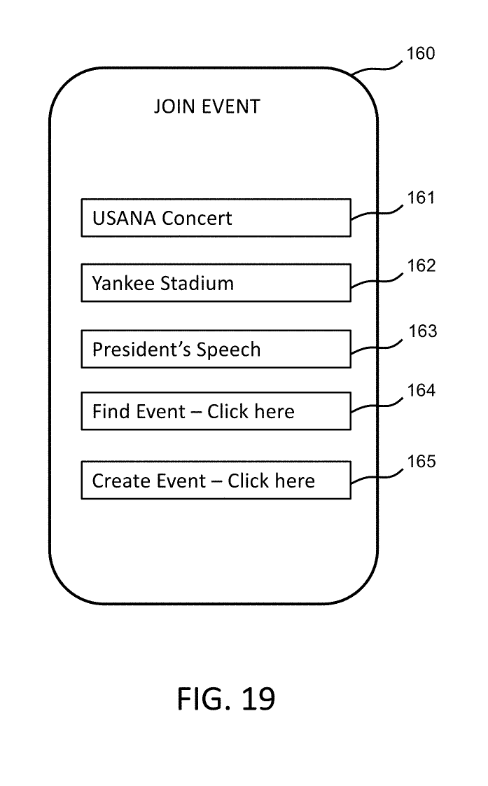

Another shared listening experience can be accomplished by a user selecting an event taking place. Turning to FIG. 19, an exemplary display interface is shown that presents exemplary controls. Various places and public forums are anticipated that a user can join. For example, control “USANA Concert” 161 allows a user to tap into a concert being held at USANA. This may include payment of a fee to join. It may also include registering for the event. In this manner, a user can at least partially experience the concert without being physically present. Similarly, “Yankee Stadium” 162 allows a user to listen to the game and the cheering crowd without actually being physically present. Even if the tickets are sold out, a user can still feel like they are present. This also allows ticket sellers to increase their sales.

In another example, Control “President's Speech” 163 allows a user to hear a President's speech that is scheduled. Control “Find Event” 164 allows a user to search online or over a network for a desired event. Control “Create Group” 165 allows a user to create an event and have others attend and/or sign up to attend.

Note that events may include previously held events such that the listening experience can extend beyond real-time listening. A database may store the event information and users then access the event information. For example, users could login and select previous events that they desire to listen to.

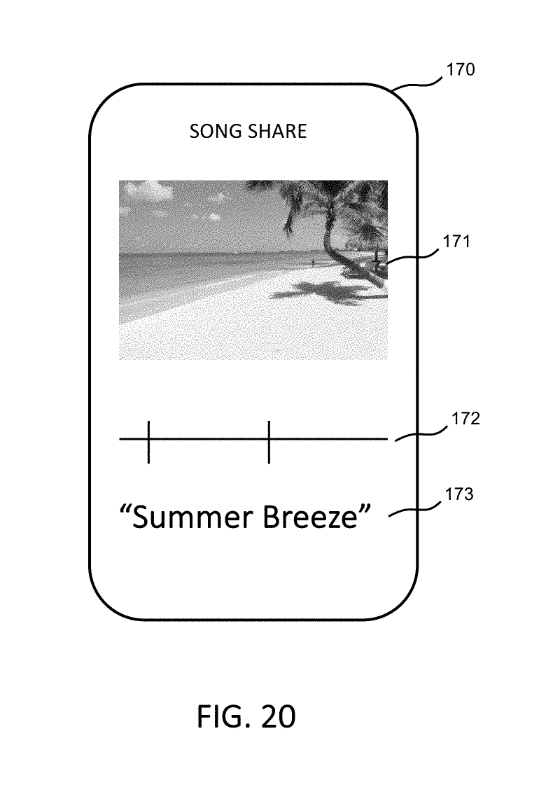

Another listening experience includes sharing songs with social media. For example, songs may be linked to pictures, locations, voice recordings, etc. A user may have the ability to link a portion of a song to a picture. Turning to FIG. 20, a picture 171 selected by the user is shown next to a song 173. The user has selected a portion of the song to be attached to the picture. The duration of the song is indicated by the bar line 172 and the portion of the song selected is indicated by the two vertical lines. The left line indicates a starting point of the song portion and the right line indicates the ending point of the song portion. The user may select the song portion in a variety of ways. For example, as shown, the vertical lines may be dragged right and left along the bar line and stopped for placement at the part of the song that is desired. The picture enhanced by the portion of the song enhances communication, letting people know they are thinking of one another or sharing what they are thinking about in relation to a given picture.

Other ways of selecting songs may be used. For example, a user may pinch on the interface, using two fingers, the ends of the portion of the song desired.

In addition, the song sharing feature may be used as part of current apps, such as Facebook, Pandora, Twitter, Snapchat, Shazam, Spotify, Apple Music, and other social media. The song sharing feature extends beyond pictures to include video, locations, and other visual media.

There may be a feature that allows the user to save any of the described listening sessions so that a user may go back and listen to the listening session at a later time. Furthermore, there may be a feature that allows the user to share the listening session with others, such as through social media, texting, email, or other communication means known. For example, it is anticipated that a user could send a private Facebook message or share a public post that includes a listening and/or media session. This could include a link to a shared session, a group session, a photo that includes a portion of a song, or any other session described herein. For people that are not connected as friends on Facebook, a request could be sent to allow messaging or other interactions that if accepted, would allow session sharing.

A user may have a paid subscription to an online musical forum (e.g. Pandora, Shazam, Apple Music, Pandora, etc.) which allows the capabilities described herein. The user may listen to a song on a forum and the forum will do a song recognition and communicate information about the song that is playing. The entire song may be selected or portions of the song be selected to be attached to a visual media, locations, or voice recording, etc.

In this manner, a user can follow people of interest. Also, the user can have a social experience by engaging in the same music of interest as friends and other people of interest.

The interface may include an interface that has controls similar to controls found in a sound studio. A user may enter another user's sound studio(s) to listen to and modify the other user's songs. For example, a user may virtually enter Dr. Dre's sound studio, listen to his songs, share music from his studio, and/or modify his songs to suit the user's taste. Songs may be used to create, for example, slideshows with pictures/video, video clips that can then be shared with other users, a collage of photos with songs, etc. The song creations can then be shared with others on social media platforms (e.g., Facebook, Instagram, Snapchat, etc.).

An exemplary studio environment may look like a real music studio, with a user-defined avatar that could sit down and use the various virtual sound recording equipment to create music content. Options include, for example, posting videos, posting social media content, filtering music, linking music, doing a live feed, editing music, adding hashtags to music content, making music videos, etc.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

What is claimed is:

1. A computer-implemented method for sharing a listening session, comprising:
providing one or more listening session identifiers;
receiving a selected listening session identifier;
providing access to a listening session associated with the selected listening session identifier.

2. The method in claim 1, wherein the listening session provided is the selected listening session.

3. The method in claim 1, wherein the listening session provided is associated with the listening session identifier.

4. The method in claim 1, further comprising confirming that the listening session associated with the identifier is available.

5. The method in claim 1, wherein the listening session provided includes a reference to a source for obtaining audio content associated with the provided listening session identifier.

6. The method in claim 1, wherein the listening session comprises real-time music being streamed to an end user.

7. The method in claim 1, wherein the listening session includes a music playlist.

8. The method in claim 1, wherein the listening session provided includes one or more user-defined customizations.

9. The method in claim 1, wherein the listening session includes previously music played to an end user.

10. The method in claim 1, wherein the music listening session is a concert or other real-time music-related performance or event.

11. The method in claim 1, wherein the music listening sessions are taken from end users listening to one or more of Pandora, Soundhorn, Amazon Music, Google Play, Shazam, Apple Music, Rdio, YouTube, Musi, SoundCloud, Beats Music, Musinow, Slacker, IHeartRadio, TuneIn, Spotify, Play Music, Tidal, Deezer.

12. The method in claim 1, further comprising displaying on the user interface a selection for creating a group listening session that can be selected as the listening session and wherein multiple users can participate in listening to the same music together.

13. The method in claim 1, further comprising displaying on the user interface a save selection wherein the selected session is saved to be listened to at a future time.

14. The method in claim 1, wherein the electronic device is an earbud and the listening session may be activated and de-activated by tapping the earbud.

15. The method in claim 5, wherein the selected session is saved for a limited time.

16. A method for sharing an online music related media listening experience comprising:
displaying on a user interface a first selection or search ability for one or more of photos, images, videos, locations, or other media content;
receiving the first selection;
displaying on the user interface a second selection or search ability for the selection of music content;
receiving the second selection;
linking the first and second selection as a media listening experience;
receiving a request to share the media listening experience;
delivering over the network the media listening experience to an end user.

17. A computer system comprising:
a processor;
a storage coupled to the processor;
at least one user interface device to receive input from a user and present material to the user in human perceptible form;
and an instruction set, stored on the storage, that when executed cause the computer system to:
present, through the user interface, a listening session identifier for selecting an audio listening session;
receive the selected identifier; and
present through an audio output interface, audio content based on the received selected identifier.
